(19) United States
(12) Patent Application Publication
(10) Pub. No.: US 2012/0024095 A1
(43) Pub. Date: Feb. 2, 2012

(54) MANUAL TRANSMISSION

(75) Inventors: Martin Lamke, Ravensburg (DE); Hermann Lanz, Frickingen (DE); Michael Ludescher, Friedrichshafen (DE); Jorg Borner, Friedrichshafen (DE); Ewgeni Bayer, Friedrichshafen (DE)

(73) Assignee: ZF FRIEDRICHSHAFEN AG, Friedrichshafen (DE)

(21) Appl. No.: 13/144,749

(22) PCT Filed: Feb. 10, 2010
(86) PCT No.: PCT/EP2010/051609

§ 371 Date: Jul. 15, 2011

(30) Foreign Application Priority Data
Mar. 16, 2009 (DE) 102009001579.5

(51) Int. Cl. F16H 1/14

(52) U.S. Cl. 74/416

(57) ABSTRACT

A manual transmission having an input shaft whose rotation is transmitted to an output shaft by a selected set of gearwheel pairs, which include gearwheels that are positioned on common axes at an angle to one another. The gearwheel pairs each comprise at least one cone-shaped gearwheel. Rotational direction reversal of the output shaft can be produced, upon actuation of a clutch, by an intermediate wheel which is positioned to one side of the arrangement axes and which engages a mating gear located on the driving side and one located on the driven side. At least one of the mating gears is conical and the intermediate wheel is cylindrical and arranged relative to the mating gears such that a rotational axis of the intermediate wheel is parallel to the lines of contact with the mating gears. The rotational axes of the intermediate wheel and each mating gear intersecting at a common point.

This application is a National Stage completion of PCT/EP2010/051609 filed Feb. 10, 2010, which claims priority from German patent application serial no. 10 2009 001 579.5 filed Mar. 16, 2009.

### FIELD OF THE INVENTION

The invention concerns a manual transmission with an input shaft whose rotational speed and torque can be transmitted, via gearing, to an output shaft by selecting one out of a plurality of shiftable gearwheel pairs formed by gearwheels located respectively on common arrangement axes on the driving and the driven sides, these arrangement axes being positioned at an angle to one another and, to enable this, the gearwheel pairs having in each case at least one conically shaped gearwheel, and such that a rotational direction reversal of the output shaft can be produced, when a clutch device is actuated, by means of an intermediate wheel which is positioned to one side of the arrangement axes and which engages with a mating gear on the driving side and with a mating gear on the driven side, at least one of the mating gears is cone-shaped.

### BACKGROUND OF THE INVENTION

Manual transmissions are used in motor vehicles and ships among other things, in order to use rotational speeds and torque provided by an internal combustion engine, via gearing, for propelling the motor vehicle or ship in accordance with the selection of one out of a plurality of gearwheel pairs in the transmission. In this context there are transmission developments in which the arrangement axes on which the respective driving-side and driven-side gearwheels of the shiftable gearwheel pair are located, are positioned at an angle to one another. This allows the position of the arrangement axes to be better adapted to the fitting space available for the transmission, and in addition the axis separation is variable whereby the individual, shiftable gearwheel pairs can be designed in an optimum manner. Overall, this either reduces the structural size of the transmission or results in an increase of transmission ratio spread.

From DE 101 51 752 A1 a manual transmission of this type is known, in which the rotational speed and torque of an input shaft can be transmitted via gearing to an output shaft by selecting one out of a plurality of shiftable gearwheel pairs. These gearwheel pairs are formed by gearwheels located on the driving side and on the driven side on respective common arrangement axes, such that the arrangement axis on the driven side corresponds to the rotational axis of the output shaft whereas the arrangement axis on the driving side is defined by a countershaft connected to the input shaft by a fixed gearwheel stage. In order, now, to produce a variable axis separation, the two arrangement axes and thus the countershaft and the output shaft are positioned at an angle to one another. Furthermore, each shiftable gearwheel pair comprises a conically shaped gearwheel in order to, despite the angled position, enable meshing with the opposite, cylindrical gearwheel. In addition, to one side of the two arrangement axes, an intermediate shaft with an intermediate wheel is provided, which meshes, on the one hand, with a mating gear on the countershaft on the driving side and, on the other hand, with a mating gear on the output shaft on the driven side and, when a clutch provided on the output shaft is actuated, brings about a rotational direction reversal that enables the vehicle fitted with the transmission to be driven in reverse.

Whereas in transmissions with respective gearwheel pairs arranged axis-parallel with one another and thus having gearwheels of purely cylindrical shape, axially supporting the intermediate wheel is superfluous since the axial forces compensate one another, in the case of arrangement axes that are inclined relative to one another, and as a function of the geometrical design and positioning of the intermediate wheel in relation to the two mating gears, additional axial force components occur, which make it necessary to provide additional axial support for the intermediate wheel. Consequently, this increases the manufacturing costs of the transmission.

### SUMMARY OF THE INVENTION

Accordingly, the purpose of the present invention is to provide a manual transmission in which arrangement axes of shiftable gearwheel pairs are positioned at an angle to one another and such that a rotational direction reversal can be produced by an intermediate wheel located to one side of the arrangement axes, which is not acted upon by axial forces.

The invention is based on the technical principle that the intermediate wheel has a cylindrical shape and is arranged, relative to the mating gears, in such manner that a rotational axis of the intermediate wheel runs parallel to the lines of contact with the mating gears. Owing to the cylindrical shape of the intermediate wheel and the feature that its lines of contact with the mating gears run parallel to its rotational axis, no additional axial forces are exerted on the intermediate wheel, while axial force produced purely due to oblique gearteeth compensate one another, since the driving and the driven engagement, as also in the case of cylindrical wheels, result in opposite force directions. Consequently, by virtue of such a design the intermediate wheel can be free from axial forces even when the arrangement axes are positioned at an angle to one another, and accordingly additional axial support at this point is not needed. The rotational axes of the intermediate wheel and the mating gears in this case intersect at a point.

In accordance with an embodiment of the invention, both mating gears are conical. In this way, the axial force components of the individual mating gears can be influenced by the respective cone angle selected, thus enabling a more uniform distribution between the two mating gears. Furthermore, larger inclination angles between the arrangement axes are also possible.

In a further development of the invention, the intermediate wheel and the mating gears are arranged in a common plane. This enables an axially more compact arrangement for producing a rotation direction reversal of the output shaft.

In an alternative embodiment of the invention the engagement of the intermediate wheel with one mating gear and its engagement with the other mating gear are located in different planes that are offset with respect to one another. This has the advantage that the space taken up in the radial direction can be smaller in each of these two planes.

In a further development of the invention, the mating gear on the driving side or that on the driven side is at the same time a gearwheel of the shiftable gearwheel pair. Thanks to this measure, the production cost of the manual transmission can be reduced further.

In accordance with another advantageous embodiment of the invention, a countershaft is positioned between the input and output shafts, and which is in active connection with the input shaft, via a fixed gearwheel stage, and with the output shaft via the shiftable gearwheel pairs. Advantageously, in this case the input and output shafts are also arranged coaxially with one another. This makes the transmission according to the invention particularly suitable for rear-wheel driven and all-wheel driven motor vehicles.

In a further embodiment of the invention the clutch device of the arrangement for producing a rotation direction reversal of the output shaft is designed in the manner of a synchronizer. In this way increased wear or even failure can be prevented by reducing still existing rotation speed differences between the mating gear concerned and the shaft carrying it.

### BRIEF DESCRIPTION OF THE DRAWINGS

Further measures that improve the invention are indicated below together with the description of preferred embodiments of the invention given with reference to the figures, which show:

FIG. 1: A perspective view of the manual transmission according to the invention in the area of an intermediate wheel, according to a first embodiment;

FIGS. 2A and 2B: Schematic diagrams illustrating the principle of the intermediate wheel with two mating gears in the manual transmission according to the invention;

FIG. 3: A perspective view of the manual transmission according to the invention in the area of an intermediate wheel, according to a second embodiment.

### DETAILED DESCRIPTION OF THE PREFERRED EMBODIMENTS

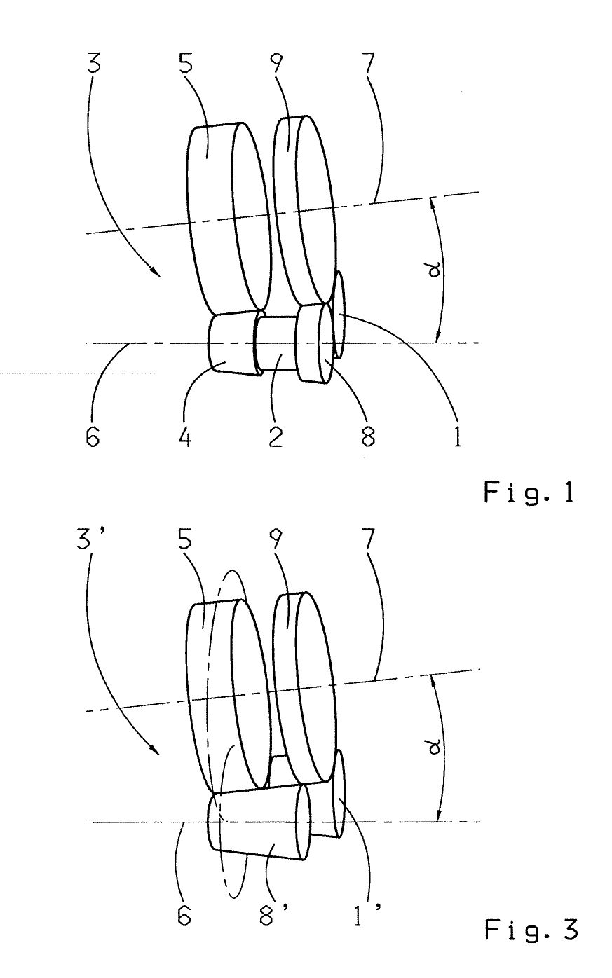

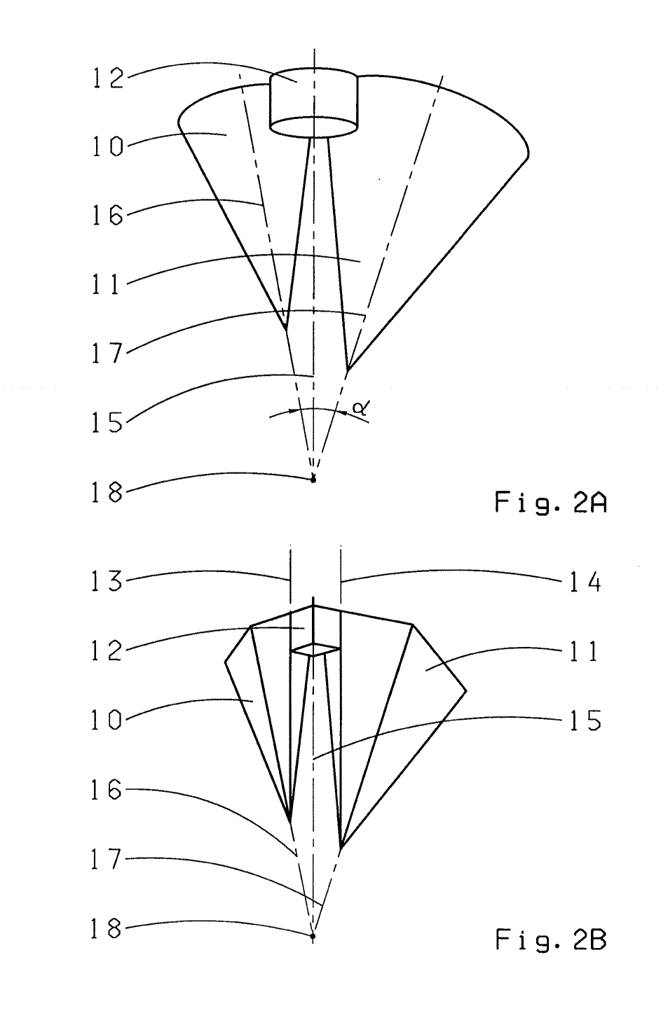

FIG. 1 shows a perspective view of a first embodiment of the manual transmission according to the invention in the area of an intermediate wheel 1. In this area the transmission has an output shaft—not shown here—and a countershaft 2, only part of which can be seen, which can be coupled to the output shaft by means of a shiftable gearwheel pair 3. To those with knowledge of the subject, it will be clear that between the output shaft and the countershaft 2 there must be provided a planetary of gearwheel stages that correspond to the number of transmission gear ratios desired, such that each individual gearwheel pair can be shifted selectively by clutch elements arranged either on the output shaft side or on the countershaft 2 side, by virtue of which the corresponding gear ratio is engaged. It will also be clear that depending on the design of the transmission, the countershaft 2 is either in active connection, via a fixed gearwheel stage, with an input shaft of the transmission, or that it is formed directly by the input shaft. In FIG. 1 the gearwheel pair 3 has a gearwheel 4 positioned on the driving side and a gearwheel 5 positioned on the driven side, which are permanently engaged with one another and are positioned on respectively associated arrangement axes 6 and 7, these arrangement axes 6 and 7 corresponding to the rotational axes of the output shaft and the countershaft 2 respectively. Furthermore, the two arrangement axes 6 and 7 are arranged at an angle α relative to one another and the gearwheels 4 and 5 are each of conical shape in order to enable power transfer from the countershaft 2 to the output shaft despite their mutually inclined position. To drive the vehicle fitted with this manual transmission in reverse by producing the rotational direction reversal of the output shaft required for this, mating gears 8 and 9 are also located on the arrangement axes 6 and 7, which are actively connected with one another via the intermediate wheel 1. In this case the output shaft's rotational direction reversal is produced, in that starting from the countershaft 2, the power flow is transmitted, via the mating gear 8, to the intermediate wheel 1 and from there to the mating gear 9 mounted on the output shaft. Whereas the mating gears 8 and 9 are again of conical shape, the intermediate wheel 1 is a cylindrical gearwheel and is positioned relative to the two mating gears 8 and 9 in such a manner that no axial force components are exerted on the intermediate wheel 1, so that axial support at that point is superfluous. To enable a better understanding, the interaction of the intermediate wheel 1 with the mating gears 8 and 9 is represented in FIGS. 2A and 2B. In these illustrations the mating gears 8 and 9 are represented by rollers 10 and 11 in the form of cones, and the intermediate wheel 1 is represented by a cylindrical roller 12. As can be seen particularly clearly from the sectioned illustration in FIG. 2B, the roller 12 representing the intermediate wheel 1 is arranged relative to the rollers 10 and 11 representing the mating gears 8 and 9 in such a manner that lines of contact 13 and 14 between them run parallel to a rotational axis 15 of the roller 12 representing the intermediate wheel 1. Consequently, in this way no axial force components are exerted on the intermediate wheel 1 by the mating gears 8 and 9, so it will be clear to those with an understanding of the subject that axial forces produced by virtue of oblique gearing, equivalent to axis-parallel spur gear stages, compensate one another. The rotation axes 16 and 17 of the rollers 10 and 11 that represent the mating gears 8 and 9 intersect with the rotational axis 15 of the roller 12 representing the intermediate wheel 1 at an intersection point 18.

FIG. 3 shows a second embodiment of the manual transmission according to the invention in the area of an intermediate wheel 1′. In contrast to the previous embodiment, in this case the contact between the mating gear 8′ and the intermediate wheel 1′ and the contact between the intermediate wheel 1′ and the mating gear 9 do not lie in the same plane. To enable this, the intermediate wheel 1′ is made correspondingly longer in the axial direction. Furthermore, the mating gear 8′ at the same time constitutes the driving-side gearwheel of the shiftable gearwheel pair 3′ and is accordingly also made longer in the axial direction.

### INDEXES

1, 1′ Intermediate wheel
2 Countershaft
3, 3′ Shiftable gearwheel pair
4 Driving-side gearwheel
5 Driven-side gearwheel
6 Driving-side arrangement axis
7 Driven-side arrangement axis
8, 8′ Driving-side mating gear
9 Driven-side mating gear
10 Roller representing a mating gear
11 Roller representing a mating gear
12 Roller representing the intermediate wheel
13 Line of contact
14 Line of contact
15 Rotational axis of intermediate wheel
16 Rotational axis of mating gear
17 Rotational axis of mating gear
18 Point of intersection
α Angle

1-8. (canceled)

9. A manual transmission comprising an input shaft comprising a rotational speed and a torque are transmittable, via gearing, to an output shaft by selecting one of a plurality of shiftable gearwheel pairs (3; 3′), which are formed by gearwheels (4, 5; 8′ 5) positioned on a driving side and a driven side on common arrangement axes (6, 7),
the arrangement axes (6, 7) being positioned at an angle (a) to one another,
the gearwheel pairs (3; 3′) each comprising at least one cone-shaped gearwheel (4, 5; 8′, 9),
a rotational direction reversal of the output shaft being produced when a clutch device is actuated, by an intermediate wheel (1; 1′) which is positioned to one side of the arrangement axes (6, 7) and which engages with a mating gear (8, 9; 8′, 9) located on the driving side and one located on the driven side,
at least one of the mating gears being conically shaped,
the intermediate wheel (1; 1′) being cylindrical and arranged relative to the mating gears (8, 9; 8′ 9) such that a rotational axis (15) of the intermediate wheel (1; 1′) extends parallel to lines of contact (13, 14) with the mating gears (8, 9; 8′, 9) with the rotational axis (15) of the intermediate wheel (1; 1′), and
a respective rotational axis (16, 17) of each of the mating gears (8, 9; 8′, 9) intersecting at a common intersection point (18).

10. The manual transmission according to claim 9, wherein the two mating gears (8, 9; 8′, 9) are both conically shaped.

11. The manual transmission according to claim 9, wherein the intermediate wheel (1) and the mating gears (8, 9) are located in a common plane.

12. The manual transmission according to claim 9, wherein the engagement of the intermediate wheel (1′) with the mating gear (8′) on the driving side and the engagement of the intermediate wheel (1′) with the mating gear (9) on the driven side are located in planes offset from one another.

13. The manual transmission according to claim 9, wherein the mating gear (8′) positioned on one of the driving side and the driven side is a gearwheel of one of the shiftable gearwheel pairs (3′).

14. The manual transmission according to claim 9, wherein a countershaft (2) is positioned between the input shaft and the output shaft, the countershaft (2) is in active connection with the input shaft, via a fixed gearwheel stage, and with the output shaft via the shiftable gearwheel pairs (3).

15. The manual transmission according to claim 14, wherein the input and output shafts are arranged coaxially with one another.

16. The manual transmission according to claim 9, wherein the clutch device is a synchronizer.

17. A manual transmission with an input shaft and an output shaft, rotation and torque of the input shaft being transmitted to the output shaft by selectively engaging one of a plurality of shiftable gearwheel pairs (3; 3′), with each shiftable gearwheel pair (3; 3′) comprising gearwheels (4, 5; 8′ 5) that are positioned on a driving side and on a driven side on common arrangement axes (6, 7),
the arrangement axes (6, 7) being positioned at an angle (a) to one another,
the gearwheel pairs (3; 3′) each comprising at least one cone-shaped gearwheel (4, 5; 8′, 9),
a direction of rotation of the output shaft being reversible by engagement of a clutch device and an intermediate wheel (1; 1′) which is positioned on one side of the arrangement axes and which engages with a mating gear (8, 9; 8′, 9) that is located on the driving side and with another mating gear (8, 9; 8′, 9) located on the driven side,
at least one of the mating gears being conically shaped,
the intermediate wheel (1; 1′) being cylindrical and arranged relative to the mating gears (8, 9; 8′ 9) such that a rotational axis (15) of the intermediate wheel (1; 1′) being parallel to lines of contact (13, 14) with the mating gears (8, 9; 8′, 9) with the rotational axis (15) of the intermediate wheel (1; 1′), and
a respective rotational axis (16, 17) of each mating gear (8, 9; 8′, 9) intersecting at a common intersection point (18).
